(19) United States
(12) Patent Application Publication
(10) Pub. No.: US 2004/0055989 A1
(43) Pub. Date: Mar. 25, 2004

(54) Sipping cup with disposable liner for toddlers and others

(76) Inventors: Nora L. Harper, Goldsboro, NC (US); Halestine Jones, Goldsboro, NC (US)

Correspondence Address: OLIVE & OLIVE, P.A., 500 MEMORIAL STREET, PO BOX 2049, DURHAM, NC, 27702, US

(21) Appl. No.: 10/252,649

(22) Filed: Sep. 23, 2002

(51) Int. Cl. A61J 11/00; A61J 9/00

(52) U.S. Cl. 215/11.3; 215/11.1

(57) ABSTRACT

A sipping cup for toddlers and others includes a reusable cup portion and securing ring and a disposable top portion and liquid holding bag. The liquid holding bag is inserted into the reusable cup portion, a desired liquid placed in the bag, a disposable top portion is placed over the liquid filled bag, and a reusable top portion is then placed on top and screwed down onto the reusable cup portion. After use, the disposable top portion and liquid holding bag may be discarded while retaining the reusable cup portion and securing ring for future reuse.

### FIELD OF THE INVENTION

The present invention is directed to toddler training and feeding aids. More particularly, the present invention relates to a sipping cup for use by toddlers and others that provides a useful, purposeful, and reusable drinking cup. The present invention sipping cup has a reusable cup portion, a disposable top portion, a reusable securing ring, and a liner or disposable bag for holding a liquid while assuring good sanitation practices.

### BACKGROUND OF THE INVENTION

A drinking cup that is designed to minimize spills, if the cup is accidentally knocked on its side, is presently available and is used especially by toddlers as they learn to handle a cup and to drink therefrom. Such cups are called sipping cups or “sippy” cups. These cups have been used for many years in the home setting.

In today's busy, hectic, fast paced society, many families find themselves in a situation where both parents must work outside the home to meet the needs of the family. Thus, many families resort to placing their young child or children in daycare settings. Growth in the number of daycare providers provides a growing market for child sanitation and daycare accoutrements.

Such daycare settings must adhere to very strict present day sanitation regulations for assuring sanitation of eating, and drinking implements. While not state regulated in all states, many states have placed daycare facilities under regulatory state health inspection. In those states, toddler sipping or “sippy” cups must be sterilized after each use and stored until next needed. Most sippy cups are formed from a rigid, hard material, e.g. plastic, and are relatively inexpensive. However, many such materials will not withstand very high temperatures necessary for sterilization. Further, many daycare facilities cannot afford the expense of having sterilization equipment in order to keep their rates affordable to parents. Thus, multiple cups must be taken, on a daily basis, to the childcare facility to insure that good sanitation is practiced at all times at the childcare facility.

Further, when traveling away from home, e.g. vacations, trips to restaurants and the like, the same sanitation requirements also need to be adhered too. As in the childcare situation, to insure good sanitation, multiple cups would be needed for a trip.

The following patents are illustrative of various cups and/or containers currently available. Some such cups and/or containers have unitary or integral bladders, liners or the like and might be employed in an attempt to overcome the aforementioned sanitation problem. None of the following however solve the problems associated with a sipping cup.

U.S. Pat. No. 5,645,191, issued Jul. 8, 1997 to Lillian Neville, disclosed a disposable, safety drinking container having a cup and a lid which, when attached to a cup, forms a drinking spout. U.S. Pat. No. 4,925,055, issued May 15, 1990 to Edward S. Robbins, III et al, discloses a self-closable dispenser cap for use with containers in general and with bladder-type containers in particular. U.S. Pat. No. 4,657,151, issued Apr. 14, 1987 to James L. Cabernoch, discloses nursing containers of the type employing a flexible liner or pouch that is collapsible upon dispensing of the contents to an infant. U.S. Pat. No. 5,005,733, issued Apr. 9, 1991 to William R. Stoody, discloses a collapsible, passive flaccid bag for use as a bottle in various kinds of dispensers. U.S. Pat. No. 3,918,605, issued Nov. 11, 1975 to Calvin J. Butler, discloses a container with a disposable closure and liner assembly that is inexpensive to manufacture and is easy to install and remove from containers. U.S. Pat. No. 5,385,251, issued Jan. 31, 1995 to Steven B. Dunn, discloses disposable, sterile, bottle bags for use in nursing or infant feeding systems. U.S. Pat. No. 5,079,013, issued Jan. 7, 1992 to Richard A. Belanger, discloses a dripless liquid training/feeding cup or bottle for babies and/or toddlers. U.S. Pat. No. 5,871,118, issued Feb. 16, 1999 to Antonio Franzese, discloses a high-density plastic beverage container attachment having a curved or beveled section releasable attached at its base to the top of a metal or aluminum beverage can or the top of a plastic or Styrofoam drink cup or container.

Accordingly, it is clear there is a need in the art for a sipping cup for toddlers and others that is of simple construction, useful, purposeful, has adaptable uses, and has intrinsic convenience.

Another object of the present invention is to eliminate the need for the clutter of carrying numerous cups to be used when away from home, including while at school or in a daycare setting, while traveling, or similar activity so commonplace in today's active society.

Another object of the present invention is to provide a sipping cup for toddlers or others that is practical and potentially indispensable for sanitary drinking activities while on the run or with groups of others, e.g. daycare facilities.

A further object of the present invention is to provide a sipping cup for toddlers, that is effective and simple to use for average consumers and which provides an economical means for having a sanitary cup for each use by the toddler.

Another object of the invention is to provide a sipping cup that eliminates the problem of sanitation of drinking cups for toddlers and the necessity of providing more than one cup for use at daycare facilities.

### SUMMARY OF THE INVENTION

The present invention provides a sipping cup for use by toddlers or others that consists of a reusable, rigid cup portion; a disposable top portion; a reusable, rigid securing ring; and a disposable bag portion. The reusable, rigid cup portion is constructed from a rigid, hard material, e.g. plastic or metal, and is shaped so that a toddler can easily hold it. The top edge of the cup is circular in shape, and has an externally threaded lip. In the center of the disposable, top portion is a raised spout-like opening through which liquids may be sipped. The reusable, rigid securing ring is internally threaded so that it can be secured to the threaded lip of the cup portion by screwing it thereon. The disposable bag portion is of such a size as to fit within the reusable, rigid cup portion to contain the liquid to be served. While an exemplary threaded embodiment is provided, it is also contemplated that a snap fit or other such arrangement would work equally as well. Also, it is contemplated that the top portion and the securing ring may be formed as a one piece, disposable item.

The present invention and its features and advantages will be more fully understood, and further features and advantages will become apparent, when reference is made to the following detailed description of the invention, including the drawings, and the claims.

### BRIEF DESCRIPTION OF THE DRAWINGS

FIG. 1 is a perspective view of an assembled sipping cup for toddlers or others according to an embodiment of the present invention.

FIG. 2 is an exploded perspective view of the FIG. 1 sipping cup for toddlers or others according to the present invention.

FIG. 3 is a section elevation view taken substantially along line 3-3 of FIG. 1.

### DESCRIPTION OF AN EMBODIMENT

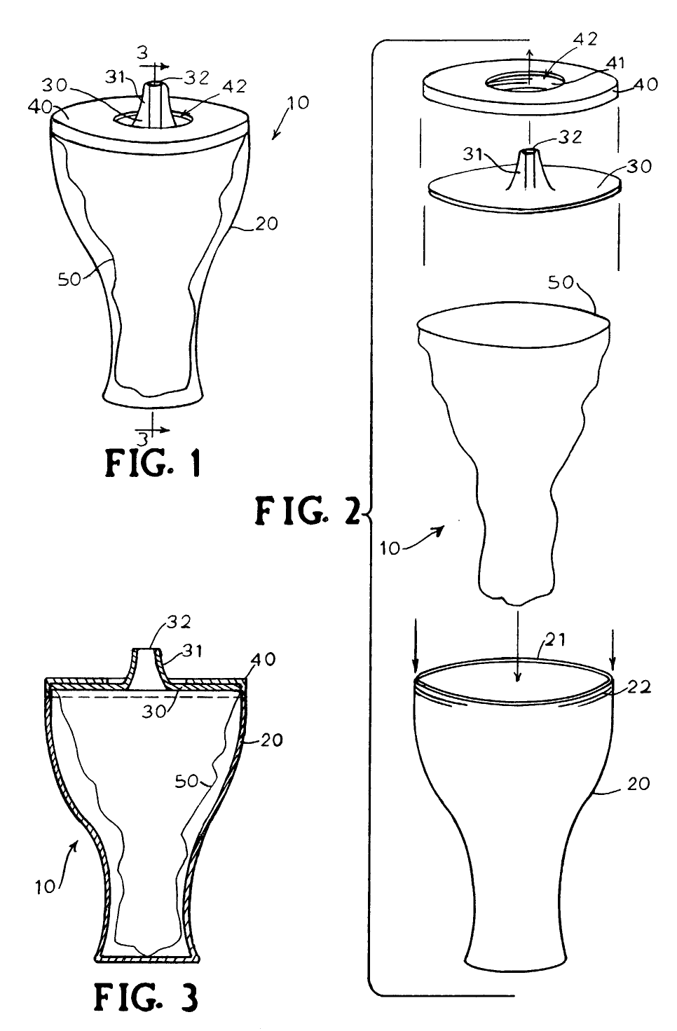

Referring to the drawings in detail, wherein like numerals indicate like elements, there is shown in FIGS. 1 through 3, an embodiment of the present invention sipping cup 10 for toddlers and others. Sipping cup 10 comprises a reusable, rigid cup portion 20, a disposable top portion 30, a reusable, rigid securing ring 40, and a disposable bag portion 50.

Cup portion 20 is reusable and is made from a rigid, hard material, e.g. plastic or metal, and is shaped so that a toddler can easily hold it. The top edge 21 of cup portion 20 has an attachment means comprising, in this embodiment, an externally threaded lip 22. Disposable top portion 30, in the preferred embodiment, is circular in shape and formed from a hard plastic. In the center of top portion 30 is a raised spout 31 with an opening 32 through which liquids are sipped by the user. Reusable, rigid securing ring 40 has internal threads 41 so that it can be threadably secured to threaded lip 22 of cup portion 20. Securing ring 40 also has a central opening or hole 42. Disposable bag portion 50 is of such a size as to fit within cup portion 20 to contain a liquid to be served to the user of the cup.

Sipping cup 10 is used by placing a disposable bag 50 into cup portion 20. Disposable bag 50 is then filled with a selected beverage. Disposable top portion 30 is next placed within securing ring 40 with spout 31 facing up and extending through hole 42 of securing ring 40. Securing ring 40 is then screwed onto the top of cup portion 20 so that threaded lip 22 and internal threads 41 of securing ring 40 mate and hold disposable top portion 30, bag 50, and securing ring 40 in place and together with hard plastic cup portion 20. Securing ring 40 is screwed onto cup portion 20 to form a liquid tight seal.

When the toddler or other user is finished with sipping cup 10, securing ring 40 is unscrewed and disposable top portion 30 and bag 50 are removed and simply thrown away. Cup 20 and securing ring 40 may be stored for use at a later time with a new top portion 30 and bag 50.

While a screw together arrangement has been illustrated, it is contemplated that a snap fit arrangement would also work. Further, it is contemplated that top portion 30 and securing ring 40 may be formed as a one piece, disposable item.

As can be seen from the above description, there is no longer a need for multiple sippy cups per child when traveling or at a daycare facility. The invention product is intrinsically useful for assuring sanitary drinking conditions for toddlers and others.

The above detailed description of the present invention sets forth the best mode contemplated by the inventor for carrying out the invention at the time of filing this application and is provided by way of example and not as a limitation. Accordingly, various modifications and variations obvious to a person of ordinary skill in the art to which it pertains are deemed to lie within the scope and spirit of the invention as set forth in the following claims.

What is claimed is:

1. A sipping cup for toddlers and others, said sipping cup comprising:
(a) a reusable cup portion;
(b) a disposable top portion;
(c) a disposable bag portion; and
(d) means for removably connecting said reusable cup portion and said disposable top portion once said disposable bag portion has been filled and placed within said reusable cup portion.

2. A sipping cup for toddlers and others as claimed in claim 1, wherein said reusable cup portion is formed from a rigid material.

3. A sipping cup for toddlers and others as claimed in claim 2, wherein said rigid material is plastic.

4. A sipping cup for toddlers and others as claimed in claim 1, wherein said disposable top portion is made of plastic.

5. A sipping cup for toddlers and others, said sipping cup comprising:
(a) a reusable cup portion;
(b) a disposable top portion;
(c) a reusable securing ring;
(d) a disposable bag portion; and
(e) means for removably connecting said top portion, said ring, and said cup portion.

6. A sipping cup for toddlers and others as claimed in claim 5, wherein said reusable cup portion has at its uppermost external edge, external screw threads formed therein; and, wherein said reusable securing ring has internal screw threads formed therein; said reusable securing ring being adapted to being screwably received by said reusable cup portion.

7. A sipping cup for toddlers and others as claimed in claim 5, wherein said means for removably connecting said top portion to said cup portion is in the form of a snap-fit connection means.

8. A sipping cup for toddlers and others as claimed in claim 5, wherein said disposable top portion is formed from a rigid plastic material.

9. A sipping cup for toddlers and others as claimed in claim 5, wherein said reusable securing ring is formed from a rigid plastic material.

10. A sipping cup for toddlers and others as claimed in claim 5, wherein said disposable bag portion is formed from a flexible collapsible material and is capable of fitting within said cup portion.

11. A sipping cup for toddlers and others as claimed in claim 10, wherein said flexible collapsible material is plastic.

12. A sipping cup for toddlers and others, said sipping cup comprising:
(a) a reusable rigid cup portion; said cup portion being shaped so a toddler or others can easily hold said cup in their hand; said cup portion having an externally threaded edge adjacent the top of said cup portion;
(b) a flexible collapsible disposable plastic bag portion; said bag portion sized to fit into said cup portion;
(c) a reusable rigid securing ring; said securing ring being shaped so as to form a continuation of said cup portion; said securing ring having an internal threaded edge adapted to screwably mate with said externally threaded edge of said cup portion;
(d) a disposable top portion; said top portion shaped so as to mate with said securing ring; and
(e) once said top portion is in place; said securing ring and said disposable top portion are screwed down onto said cup portion thus providing a sipping cup for toddlers and others.
